(19) United States
(12) Patent Application Publication
(10) Pub. No.: US 2006/0206521 A1
(43) Pub. Date: Sep. 14, 2006

(54) Document management device, document management method and document management program

(75) Inventor: Noriyuki Komamura, Mishima-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/077,774

(22) Filed: Mar. 10, 2005

(51) Int. Cl. G06F 17/00

(52) U.S. Cl. 707/104.1

(57) ABSTRACT

There is disclosed a document management device, a document management method, and a document management program capable of contributing a reduction of burdens on document data management. The document management device comprising: a document image display controller which displays a predetermined image corresponding to selected document data; a classification display controller which displays, in a classified manner, the document data to be managed according to a predetermined classification; and a highlight display controller which highlights a predetermined image area related to the document data displayed by the document image display controller in the image area displayed by the classification display controller.

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND OF THE INVENTION

1. Field of the Invention

The present invention relates to a document management device, a document management method, and a document management program.

2. Description of the Related Art

A conventional art that image-displays contents of arbitrarily document data selected from data files to be managed on a predetermined display area to allow a user or the like to grasp the contents has conventionally known.

However, in the conventional art, when the contents of arbitrary document data are image-displayed, it takes a lot of trouble to grasp where the document data that is being image-displayed is located in the storage area for the document data to be managed, which has impeded a reduction of management burdens in document data management.

The present invention has been made to solve the above problem, and an object thereof is to provide a document management device, a document management method, and a document management program capable of contributing a reduction of burdens on document data management.

### BRIEF DESCRIPTION OF THE DRAWINGS

FIG. 1 is a block diagram for explaining a document management device according to an embodiment of the present invention.

FIG. 2 is a flowchart showing the flow during which the document management device 1 according to the embodiment has found out a new or updated file and registered the file.

FIG. 3 is a view showing an example of a file list of the document data.

FIG. 4 is a view showing an example of a file list of the document data.

FIG. 5 is an example of a document management table before document registration.

FIG. 6 is an example of a color table.

FIG. 7 is an example of a document management table in which data files are sorted b!y their document time.

FIG. 8 is a flowchart for explaining an image creation process performed based on the document data stored in a data storage section 103.

FIG. 9 shows a state of the document management table when the image creation process has been completed.

FIG. 10 is a flowchart showing the flow of processes that display an image on a not shown display section based on the document data.

FIG. 11 is a view for explaining the image display of the document data in a document image display area 301b.

FIG. 12 is a flowchart showing the flow of a document map creation process in a data management section 101.

FIG. 13 is a flowchart showing the flow of a display switching process of the document data image when the document data is image-displayed on a not shown display section.

FIG. 14 is a flowchart showing the flow of processes in a document management method according to the embodiment.

FIG. 15 is a view for explaining a state where the document data is displayed by a document image display controller.

FIG. 16 is a view showing a window for setting classification display.

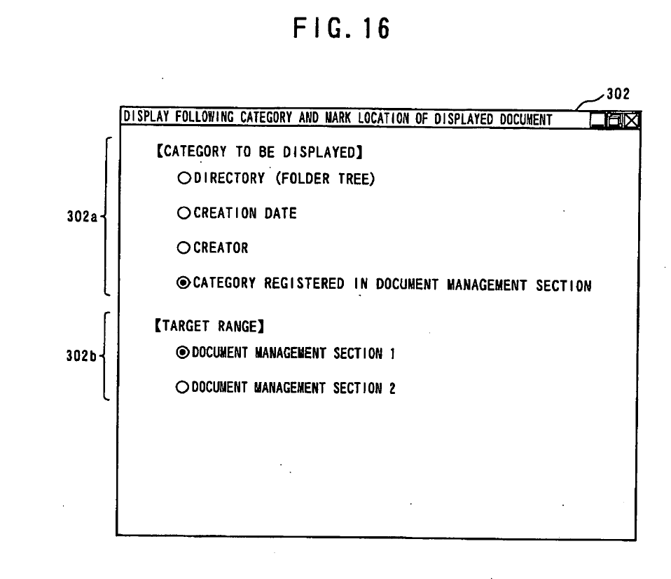

FIG. 17 is a view showing an example of highlight display.

FIG. 18 is a view showing an example of highlight display.

### DETAILED DESCRIPTION OP THE INVENTION

An embodiment of the present invention will be described below with reference to the accompanying drawings.

Throughout this description, the embodiments and examples shown should be considered as exemplars, rather than limitations on the apparatus, methods and programs of the present invention.

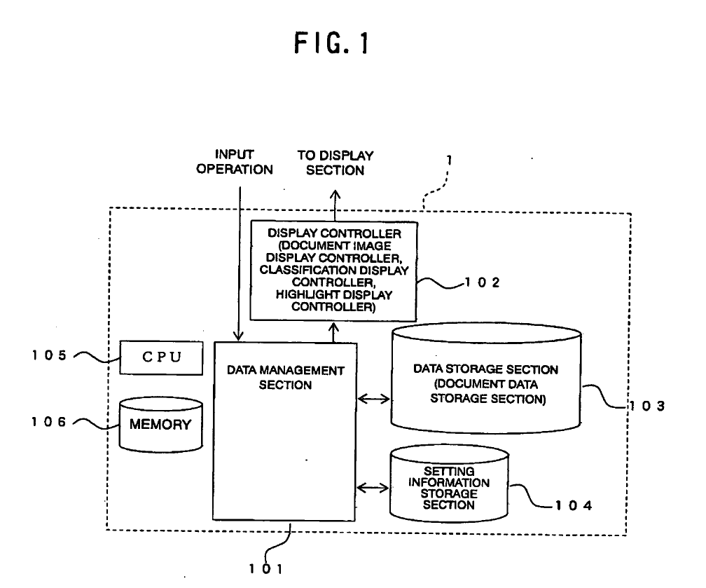

FIG. 1 is a functional block diagram for explaining a document management device according to the embodiment of the present invention.

The function of the document management device 1 according to the embodiment is realized by, for example, a PC (Personal Computer). More concretely, the document management device 1 includes a data management section 101, a display controller 102, a data storage section 103, a setting information storage section 104, a CPU 105, and a memory 106.

The data management section 101 has a role of receiving a user's input operation as well as performing various processes related to the document data to be managed. The display controller 102 has a role of allowing a not shown display section, which is connected to the document management device 1 in a communicable manner, to display a desired image. The data storage section 103 has a role of storing document data to be managed in the document management device 1, history information related to the document data, and the like. The setting information storage section 104 has a role of storing various setting information set for the document data in the document management device 1. The CPU 105 has a role of performing various processes in the document management device 1 as well as executing programs stored in the memory 106 to realize various functions. The memory 106 is constituted by, for example, an ROM, an RAM, or the like, and has a role of storing various information and programs used in the document management device 1.

The data storage section 103 and setting information storage section 104 are included in the document management device I in the present embodiment. However, the present invention is not limited to this. For example, functions of the sections 103 and 104 may be incorporated in an external device connected to the document management device 1 in a communicable manner.

The flow of the entire process in the document management device 1 according to the embodiment will next be described.

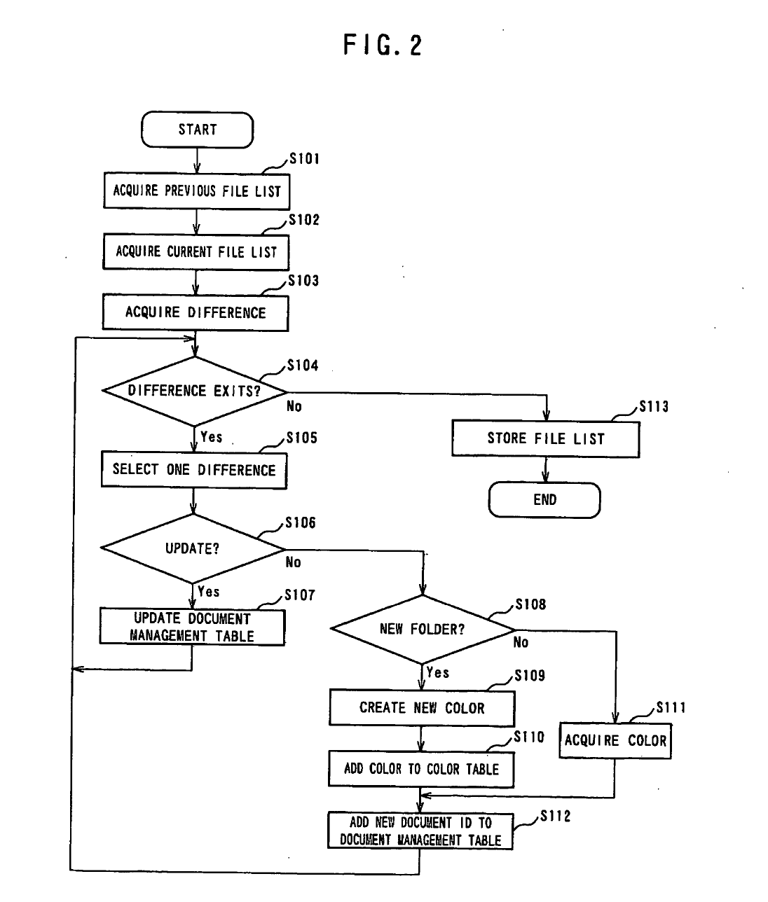

FIG. 2 is a flowchart showing the flow during which the document management device 2 according to the embodiment has found out a new or updated file and registered the file.

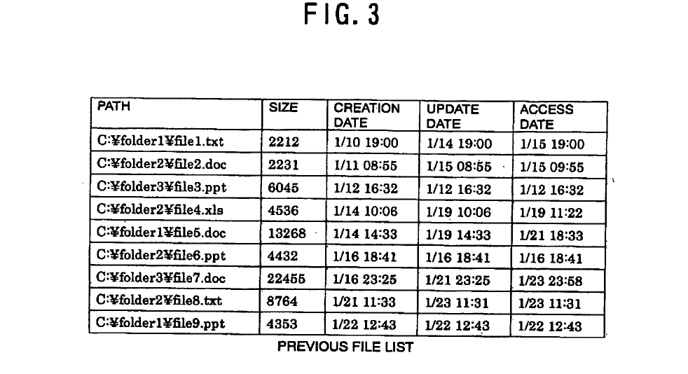

When the document management device 1 is started, the data management section 101 calls up a previous file list from the data storage section 103 (S101). The previous file list includes, as shown in FIG. 3, fields such as “file path”, “file size”, “file creation date”, “file update date”, and “file access date”.

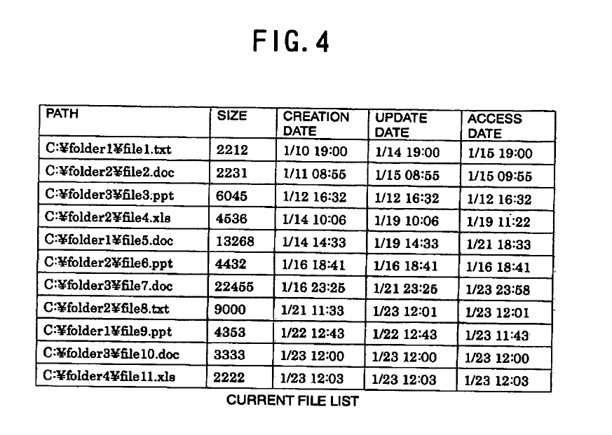

The data management section 101 then acquires a current file list from the data storage section 103 (S102). The current file list and previous file list have the same format, as shown in FIG. 4.

The data management section 101 extracts a difference between the previous and current file lists acquired as described above (S103). In this example, update times of “C:\folder2\file8.txt” are different between the previous and current file lists, and “C:\folder3\file10.doc” and “C:\folder4\file11.xls” are newly added to the current file list. Note that the field “access date” is not included in targets of the difference detection in this embodiment.

When some differences are left unprocessed (Yes in S104), the data management section 101 selects one difference (S105) and, when the difference relates to a file that exists in the previous file list and has different update times between the previous and current file lists (Yes in S106), updates a state of the corresponding document in the document management table to “UPDATE” (S107). In this example, update time of “C:\folder2\file8.txt” are different.

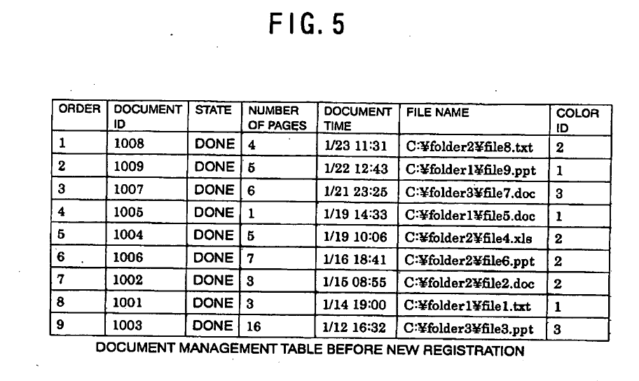

FIG. 5 is an example of a document management table before document registration. When “C:\folder2\file8.txt” has been processed the fields “document time” and “state” of the corresponding record in the document management table are updated.

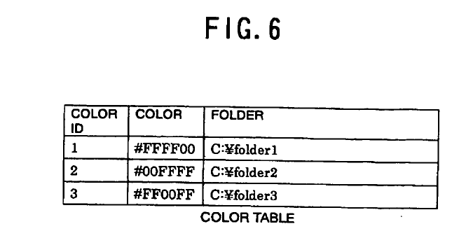

In step 106, when the difference relates to a new file that has not existed in the previous file list, whether the new file belongs to a new folder is confirmed using a color table as shown in FIG. 6 (S108).

FIG. 6 is a list of the colors assigned to folder paths that have appeared up to now and its folder. In this example although a specific color has already been assigned to “C:\folder3” that stores “C:\folder3\file10.doc”, it has not been assigned to “C:\folder4” that stores “C:\folder4\file11.xls”. From this it can be seen that “C:\folder4”0 is a new folder.

Therefore, when processing “C:\folder4\file11.xls”, the system of the document management apparatus 1 detects that a color has not been assigned to “C:\folder4”, creates an unused now color (S109) and adds the new folder path (“C:\folder4”) to the color table in association with a new non-overlapping color ID and created color to complete storing the new folder path (“C:\folder4”) in the color table (S110).

When processing “C:\folder3\file10.doc” in step 108, the system finds out that “C:\folder3” has already been registered in the color table and acquires color ID (3) assigned to “C:\folder3” (S111).

The data management section 101 acquires a new document ID and adds it to the document management table together with color ID, update time, and file name (S112).

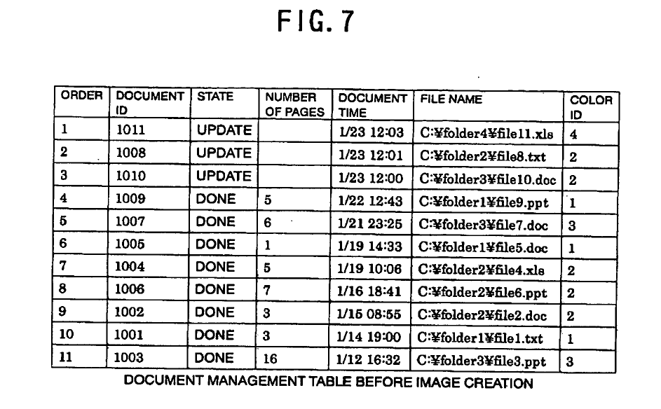

FIG. 7 is an example of a document management table in which data files are sorted by their document time after completion of the above sequence of processes.

When all differences have been processed (No in S104), the current file list is stored (S113) and the sequence of processes is ended. The file list that has been stored in this manner will be used as “previous file list” when the system is started next time.

After completion of the above document registration process, the data management section 101 creates an image for image display.

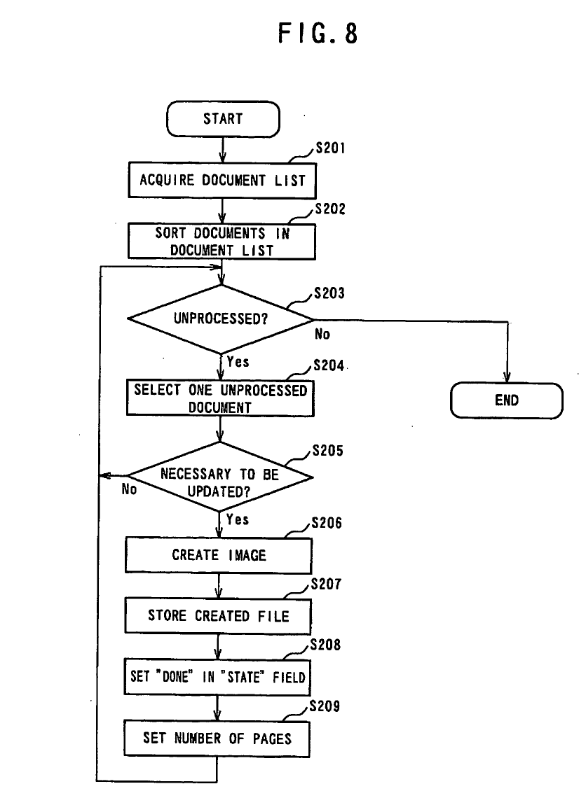

FIG. 8 is a flowchart for explaining an image creation process performed based on the document data stored in a data storage section 103. The image created in this process is image-displayed on a not shown display section by the display controller 102.

When the image creation process is started, the data management section 101 acquires a list of documents (S201) from the data storage section 103 and sorts the acquired documents by document time or the like (see FIG. 7) (S202).

When some documents in the acquired document list are left unprocessed (Yes in S203), the data management section 101 selects one unprocessed document (S204) and checks “state” field of the selected document. When the “state” field denotes “UPDATE” (Yes in S205), the data management section 101 creates a bit-map image of the document whose “state” has been updated using an image creation means (S206).

In the present embodiment, one image file is created for each page of the document. For example, file name “Document ID-Page number.jpg” is appended to the created image file. However, the format of the file name is not limited to this, and any format can be used as long as a display image can be acquired based on document ID and page number.

For example, when three page images are created from “C:\folder4\file11.xls” whose document ID is 1011, file names “1011-001.jpg” “1011-002.jpg” “1011-003.jpg” are appended to the created three image files.

The data management section 101 stores (S207) these three files in the data storage section 103 and changes “state” field of the document whose ID is “1011” on the document management table into “DONE” (S208). The data management section 101 then specifies the number of pages based on the created file numbers to set “Number of pages” of the document whose ID is “1011” on the document management table to “3”.

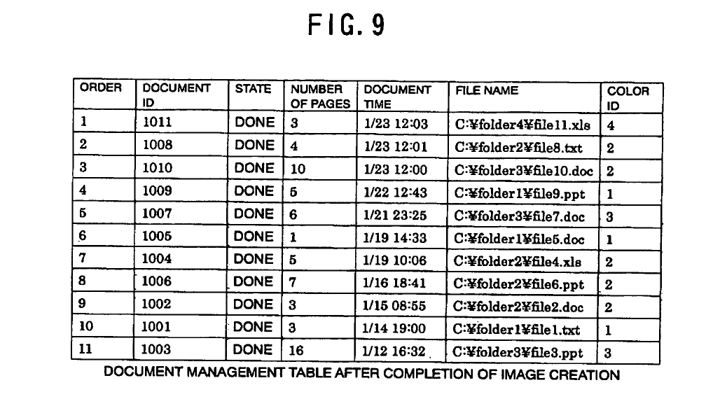

When no unprocessed files remain (No in S203), the data management section 101 ends the image creation process. FIG. 9 shows a state of the document management table when the image creation process has been completed.

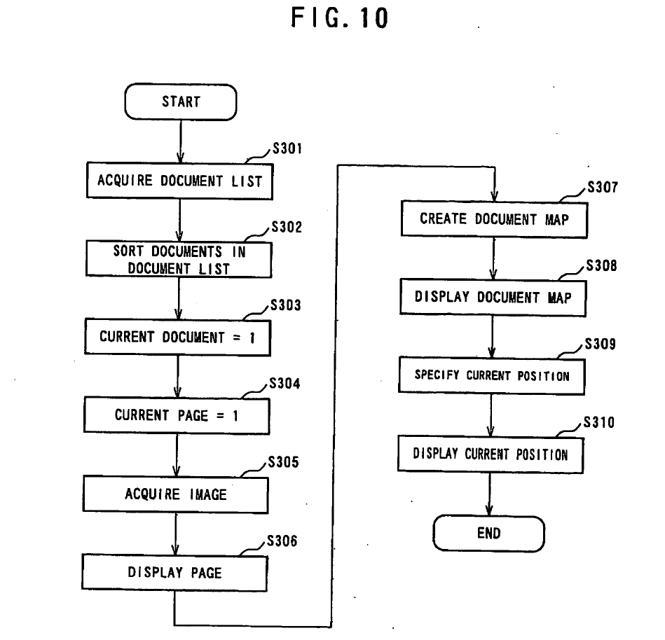

FIG. 10 is a flowchart showing the flow of processes that display an image on a not shown display section based on the document data.

The data management section 101 firstly reads in the document management table as shown in FIG. 9 from the data storage section 103 (S301). The data management section 101 sorts the items in the read-in document management table by document time in reverse chronological order (S302) and set the current document to “1” (S303). The current document is represented by “order” field in the document management table.

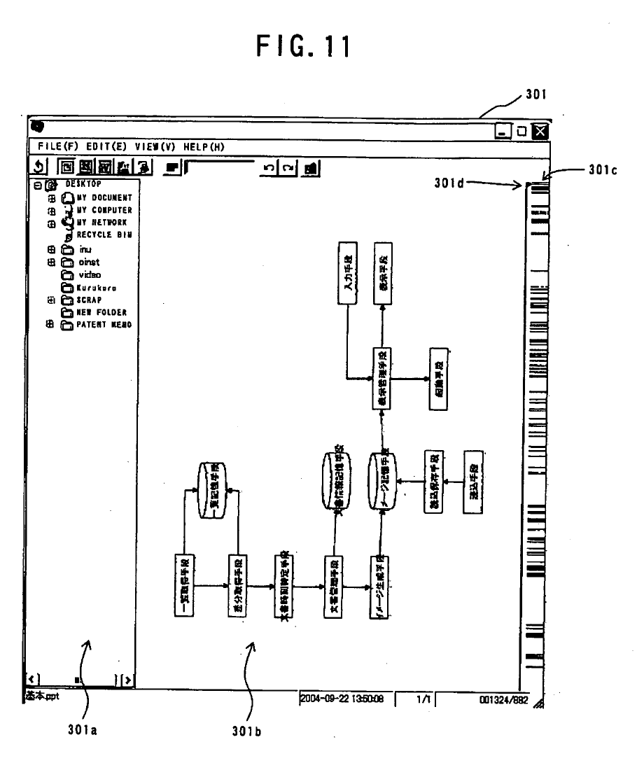

The data management section 101 sets the current page to page 1 (S304) and allows the display controller 102 to image-display the current page in a document image display area 301b of the window 301 as shown in FIG. 11 (S305). In the image display process of the page, the document management section 101 refers to the document management table based on the order of the current document to acquire document ID and specifies the corresponding image file by document ID and page number. In this example, document ID corresponding to order 1 is “1011”, so that the image file of the first page of document whose ID is “1011” has been stored with the file name “1011-001.jpg” appended thereto. Therefore, the data management section 101 allows the display controller 102 to display “1011-001.jpg”.

Next, the document management section 101 creates a document map representing the sorting order of all documents (S307) and allows the display controller 102 to display the created document map, as a document map 301c in the right side of the document image display area 301b of the window 301 on a not shown display section (S308). The document management section 101 then specifies the position of the current document on the document map 301c (S309) and allows the display controller 102 to display a current position pointer 301d on the document map in a superposing manner (S310).

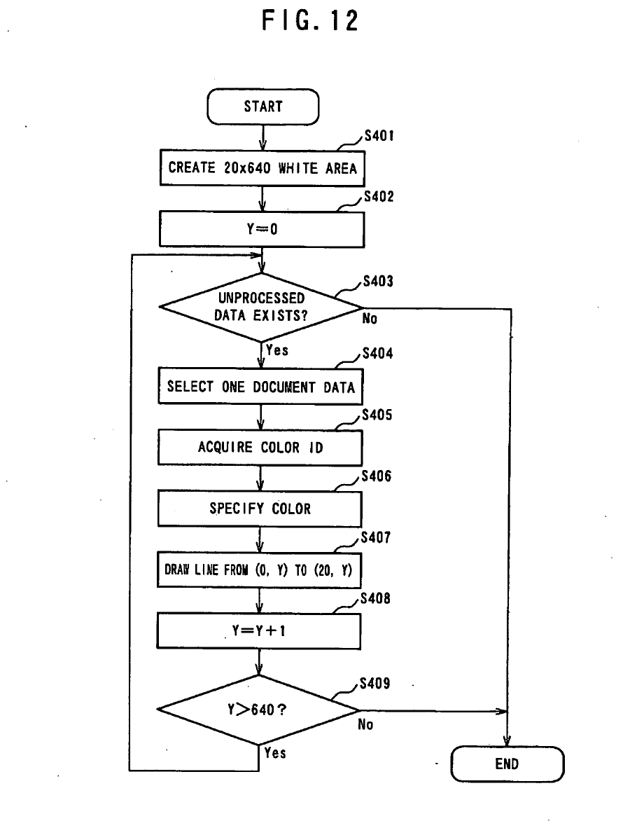

FIG. 12 is a flowchart showing the flow of a document map creation process in the data management section 101.

When receiving an instruction of a document map creation process, the data management section 101 firstly assures a white image area corresponding to the size of the document map (in this case, 20×640 pixel) (S401).

The data management section 101 then sets Y-coordinate, which is drawing starting point, to “0” (uppermost part) (S402). When some documents are left unprocessed in the document management table of FIG. 9 (Yes in S403), the data management section 101 selects one unprocessed document having smallest number in “order” field (S404) and acquires color ID assigned to the selected document (S405).

After that, the data management section 101 refers to the color table using the acquired color ID and acquires a corresponding actual color (S406).

The data management section 101 uses the acquired color to draw one pixel height line from the coordinate (0, Y) to (20, Y) of the document map area created in step 401 (S407).

The data management section 101 then increments the value of Y by 1 (moving downward by one pixel) (S408). When the value of Y has exceeded the height of the document map (Yes in S409), the document management section 101 ends the drawing. On the other hand, when the value of Y has not exceeded the height of the document map (No in S409), the document management section 101 returns to step S403 and processes the next document.

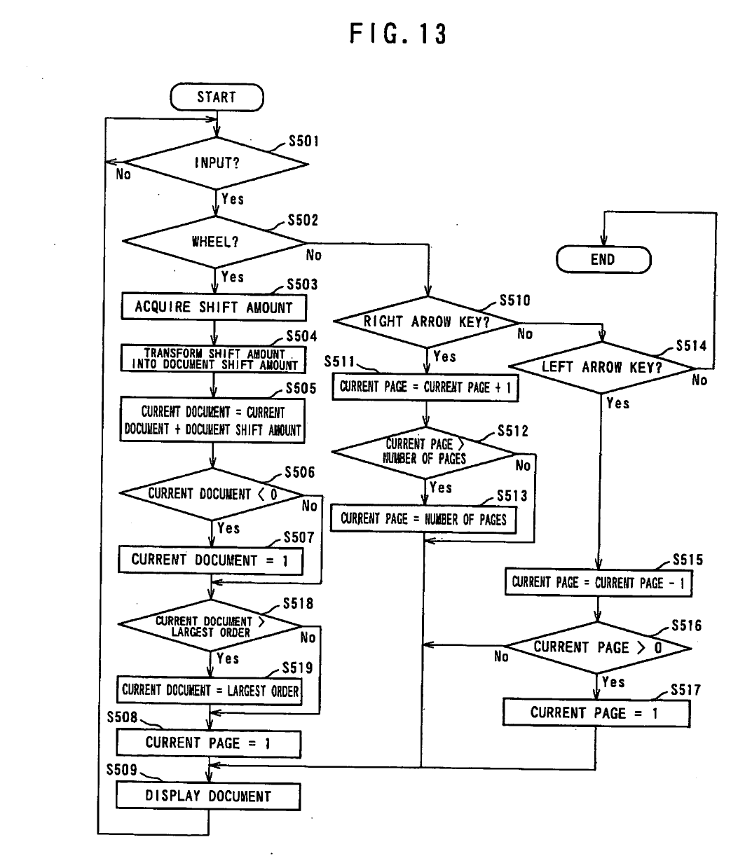

FIG. 13 is a flowchart showing the flow of a display switching process of the document data image when the document data is image-displayed on a not shown display section.

Firstly, an image of the first page of the document data having the newest update time is displayed by the process shown in FIG. 12.

The data management section 101 waits for a user's input operation (S501). When the shift amount of a mouse wheel or the like is given by the input operation (Yes in S502), the data management section 101 acquires the shift amount of the mouse wheel (S503) and determines the number of documents to be moved from the acquired shift amount (S504).

Windows™, for example, detects a shift amount of “2880” (this value changes depending on the device type or setting) for each rotation of a usual mouse wheel. However, the shift amount of “2880” is too large to find out the target document. To cope with this problem, notches of the mouse wheel configured to give a constant shift amount with each notch is used to switch the documents one by one, thereby obtaining satisfactory operability. In this example, the number of documents to be moved is determined using “120 (shift amount)=1 document” which is a value generally used.

Subsequently, the document management section 101 adds the number of documents to be moved to the current document (S505). At this time, a positive value is created when the mouse wheel is rolled backward and a negative value is created when the mouth wheel is rolled forward, so that simply by adding the value, operation in upward and downward directions can be represented.

When the value of the current document has become less than 0 (Yes in S506), the document management section 101 sets the value of the current document to 1 (S507). On the other hand, when the value of the current document has exceeded the largest order (S518), the document management section 101 re-sets the value of the current document to the largest order (S519).

After switching of the document, the data management section 101 sets a page to be displayed to the first page (S508) and allows the display controller 102 to display the document (S509).

As is the case with the process shown in FIG. 10, when displaying the image file of the document, the document management section 101 refers to the document management table based on the order information to acquire document ID, and specifies the corresponding image file by document ID and page number.

Assume that the input value is not the shift amount of the mouse wheel in step 502 (No in S502). In this case, when the input is performed using a right arrow key (Yes in S510), the document management section 101 increments the value of the current document by one (S511), acquires the number of pages of the current document from the document management table and confirms that the current page to be displayed has not exceeded the acquired number of pages (S512). If the current page to be displayed has exceeded (has become larger than) the acquired number of pages, the data management section 101 sets back the current page to the number of pages of the current document (S513).

On the other hand, when the input is performed not with a right arrow key, but with a left arrow key (Yes in S514), the data management section 101 decrements the current page by one (S515) and confirms that the page to be displayed has preceded the first page (S516). If the page to be displayed has preceded (has become smaller than) the first page, the data management section 101 sets back the current page to 1 (S517).

As described above, the document management device 1 displays a predetermined image corresponding to the document data to be managed in the document image display area 301b of the not shown display section in a switchable manner as well as displays a document map in which the documents to be managed has been sorted by a predetermined rule simultaneously with the document image display area. Further, the display controller 102 displays, in a hierarchical fashion, the documents to be managed based on a predetermined classification using folders in a classification display area 301a (see FIG. 11) of the window 301.

The details of the processes in the document management device according to the embodiment will next be described.

The display controller 102 of the document management device 1 according to the embodiment functions also as a document image display controller, classification display controller, and highlight display controller. The data storage section 103 functions also as a document data storage section.

The document image display controller has a role of allowing the display section to display a predetermined image corresponding to the document data selected by a user's input operation or the like. The classification display controller has a role of displaying, in a hierarchical fashion (in a classified fashion), the documents to be managed based on a predetermined classification using folders.

The highlight display controller has a role of highlighting a predetermined image area related to the document data displayed by the document image display controller in the image area displayed by the classification display controller. The document data storage section has a role of storing the document data to be managed.

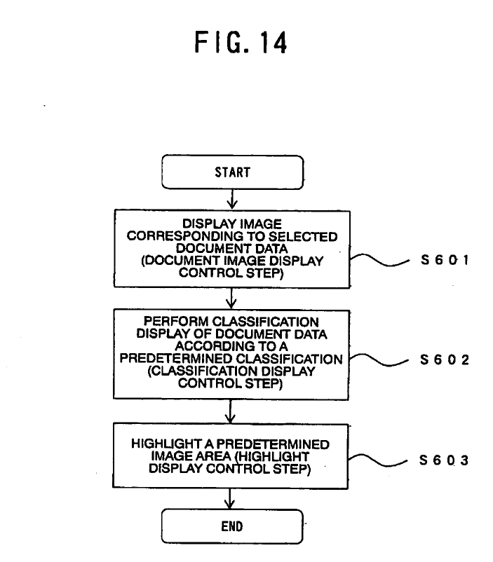

A document management method according to the embodiment of the present invention will next be described. FIG. 14 is a flowchart showing the flow of processes in the document management method according to the embodiment.

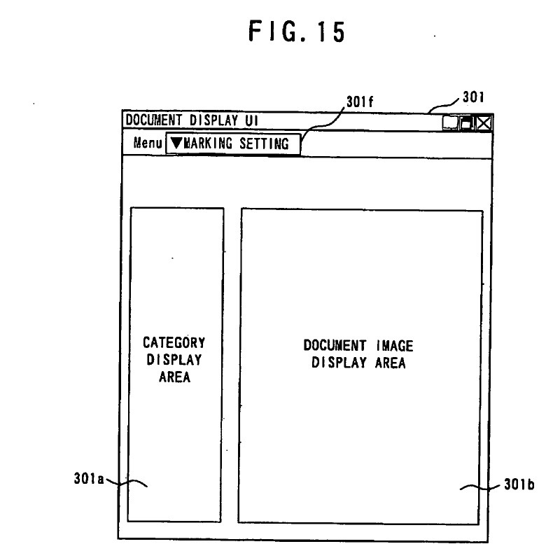

The document image display controller allows a not-shown display section to display a predetermined image corresponding to the document data managed in the manner as described above and selected by a user's operation (the document corresponding to the position indicated by the document pointer 301d on the document map 301c) in the document image display area 301b of the window 301 (document image display control step) (S601) (see FIG. 15).

The classification display controller displays the document data to be managed in a classification display area 301a of the window 301 in a classified manner based on a predetermined classification (classification display control step) (S602). At this time, the classification display controller can display, in a hierarchical fashion, the document data to be managed based on a predetermined classification using folders. Examples of a classification of the document data may include the date, extension of files, application software to deal with the document data, and file size. In addition, a user can arbitrarily set the classification.

The setting of the classification display in the classification display area 301a can be made on a setting window 302 (see PIG. 16) to be displayed by selecting a “marking” button 301f on the window 301 (document map 301c is omitted for simplicity of explanation) shown in FIG. 15. As shown in PIG. 16, a selection item 302a is displayed on the setting window 302. The item 302a is used for arbitrarily selecting, as a category to be displayed in a classified manner, one of “folder tree”, “creation date”, “creator” and “category registered in document management device”. Further, on the setting window 302, selection item 302b for arbitrarily setting a range of the document data to be displayed in a classified manner in the classification display area 301a is displayed.

The highlight display controller highlights a predetermined image area related to the document data displayed, in the document image display area 301b, by the document image display control step in the image area (classification display area 301a) displayed by the classification display control step (highlight display control step) (S603).

Concrete examples of the highlight display performed for a predetermined image area include a change in display color, a change in texture, a change in display size, a change in shape, and a change in time intervals at which an icon or the like is displayed (blinking) Theses changes are applied, for example, to a folder icon representing the upper directory that the document data directly belongs to (image area related to the folder that the document data displayed by the document image display control step belongs to), a directory path up to the document data, or the lowest folder or the like in the directory that the document data that is being displayed at that time belongs to.

In the case where a plurality of folders that the document data displayed by the document image display control step belongs to are displayed in the classification display control step, the predetermined image area includes at least the lowest folder among the above folders.

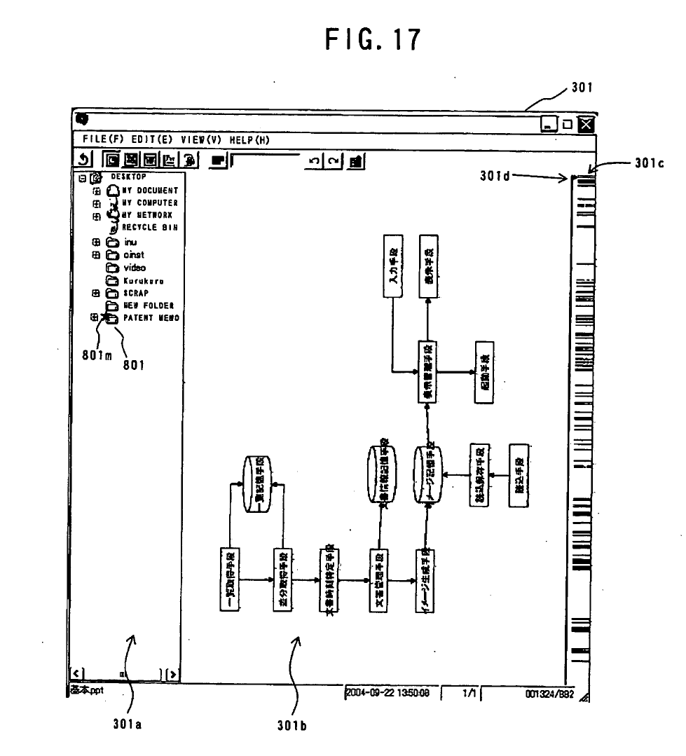

For example, assume that document data “fundamental.ppt” whose location is “desktop/patent memo/fundamental.ppt” has been selected and displayed in the document image display area 301b. In this case, when folder expansion has been made only up to “patent memo” folder as shown in FIG. 17, the “patent memo” is the lowest folder. Therefore, by marking a star 801m with the “patent memo” folder 801, the highlight display controller highlights the “patent memo” folder 801.

Assume that it is possible to classify the document data stored in the document data storage section by “date” (or assume that the document data stored in the document data storage section has already been classified by “date”), and that folders representing “month” each includes a folder representing “week” and the “week” folder includes a folder representing “date”. In this case, when the image of the document data created on “30 January” is displayed by the document image display controller, “January” folder is highlighted in a sub area in which folders representing “month” are listed.

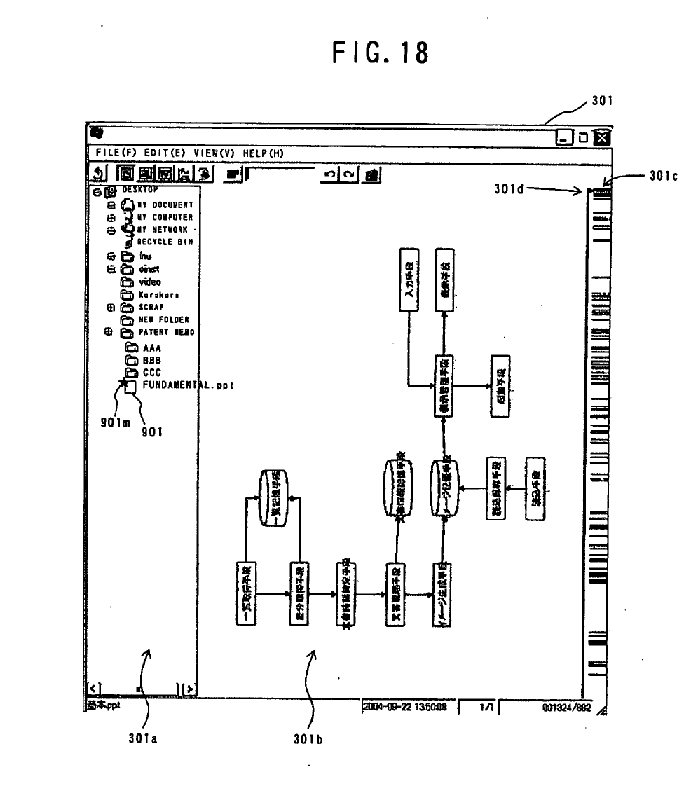

Further, as shown in FIG. 18, when an icon image 901 (in this case, “fundamental.ppt” icon) corresponding to the document data displayed by the document image display control step Is displayed in the classification display area 301a, the icon image is included at least in the image area that is highlighted by a star 901m.

By following folders (tree) thus highlighted, a user can reach the document data displayed by the document display controller.

In the case where document data such as a database located on an external device communicable with the document management device 1 is managed by the data management section 101, when the data storage section 103 stores the same document data as that registered in the database, a user may more easily manage the file by the classification set in the user's own document management device 1, in some cases.

In order to cope with the case, when a predetermined image corresponding to the document data stored in the document data storage section is displayed by the document image display controller, the classification display controller performs classification display in the classification display area 301a, based on the classification assigned to the document data that has been set in the document data storage section.

Respective steps in the above document management method are carried out by a document management program stored in the memory 106, which is executed by the CPU 105.

As described above, according to the present invention, it is possible for a user to grasp the location of the document data that has been selected and displayed. Further, when searching the displayed document data, the highlight display as described above allows the user to easily find out the document data in the course of following the hierarchy structure.

Although shown implemented in a personal computer, the invention may be implemented with any computing device. A computing device as used herein refers to any device with a processor, memory and a storage device that may execute instructions including, but not limited to, personal computers, server computers, computing tablets, set top boxes, video game systems, personal video recorders, telephones, personal digital assistants (PDAs), portable computers, and laptop computers. These computing devices may run any operating system, including, for example, variations of the Linux, Unix, MS-DOS, Microsoft Windows, Palm OS, and Apple Mac OS X operating systems.

Although the techniques discussed herein are described with regard to a compact disk, the techniques may be implemented with any storage media in any storage device included with or otherwise coupled or attached to a computing device. These storage media include, for example, magnetic media such as hard disks, floppy disks and tape; optical media such as compact disks (CD-ROM and CD-RW) and digital versatile disks (DVD and DVD±RW); flash memory cards; and any other storage media. As used herein, a storage device is a device that allows for reading and/or writing to a storage medium. Storage devices include, hard disk drives, DVD drives, flash memory devices, and others.

By data unit, it is meant a frame, cell, datagram, packet or other unit of information.

While there has been described in detail the present invention according to a specific aspect, it will be apparent to those skilled in the art that various changes and modifications can be made without departing from the scope or spirit of the subject matter of the invention.

As described above in detail, according to the present invention, there can be provided a document management device, a document management method, and a document management program capable of contributing a reduction of burdens on document data management.

It is claimed:

1. A document management device comprising:
a document image display controller which displays a predetermined image corresponding to selected document data;
a classification display controller which displays, in a classified manner, the document data to be managed according to a predetermined classification; and
a highlight display controller which highlights a predetermined image area related to the document data displayed by the document image display controller in the image area displayed by the classification display controller.

2. The document management device according to claim 1, wherein
the classification display controller displays the document data according to a predetermined classification in a hierarchical fashion, and
the predetermined image area is an image area related to the folder that the document data displayed by the document image display controller belongs to.

3. The document management device according to claim 2, wherein
in the case where a plurality of folders that the document data displayed by the document image display controller belongs to are displayed in the classification display controller, the predetermined image area includes at least the lowest folder among the above folders.

4. The document management device according to claim 1, wherein
when an icon image corresponding to the document data displayed by the document image display controller is displayed in the classification display controller, the predetermined image area includes at least the icon image.

5. The document management device according to claim 1, wherein
the highlight display controller performs highlight display by changing at least one of display color, texture, display size, shape of the predetermined image area, and time intervals at which the predetermined image area is displayed.

6. The document management device according to claim 1, comprising
a document data storage section which stores the document data to be managed,
wherein when a predetermined image corresponding to the document data stored in the document data storage section is displayed by the document image display controller, the classification display controller performs classification display according to the classification assigned to the document data that has been set in the document data storage section.

7. A document management method comprising:
a document image display control step which displays a predetermined image corresponding to selected document data;
a classification display control step which displays, in a classified manner, the document data to be managed according to a predetermined classification; and
a highlight display control step which highlights a predetermined image area related to the document data displayed by the document image display control step in the image area displayed by the classification display control step.

8. The document management method according to claim 7, wherein
the classification display control step displays the document data according to a predetermined classification in a hierarchical fashion, and
the predetermined image area is an image area related to the folder that the document data displayed by the document image display control step belongs to.

9. The document management method according to claim 8, wherein
in the case where a plurality of folders that the document data displayed by the document image display control step belongs to are displayed in the classification display control step, the predetermined image area includes at least the lowest folder among the above folders.

10. The document management method according to claim 7, wherein
when an icon image corresponding to the document data displayed by the document image display control step is displayed in the classification display control step, the predetermined image area includes at least the icon image.

11. The document management method according to claim 7, wherein
the highlight display control step performs highlight display by changing at least one of display color, texture, display size, shape of the predetermined image area, and time intervals at which the predetermined image area is displayed.

12. The document management method according to claim 7, comprising
a document data storage step which stores the document data to be managed,
wherein when a predetermined image corresponding to the document data stored in the document data storage step is displayed by the document image display control step, the classification display control step performs classification display according to the classification assigned to the document data that has been set in the document data storage step.

13. A document management program making a computer to execute:
a document image display control step which displays a predetermined image corresponding to selected document data;
a classification display control step which displays., in a classified manner, the document data to be managed according to a predetermined classification; and
a highlight display control step which highlights a predetermined image area related to the document data displayed by the document image display control step in the image area displayed by the classification display control step.

14. The document management program according to claim 13, wherein
the classification display control step displays the document data according to a predetermined classification in a hierarchical fashion, and
the predetermined image area Is an image area related to the folder that the document data displayed by the document image display control step belongs to.

15. The document management program according to claim 14, wherein
in the case where a plurality of folders that the document data displayed by the document image display control step belongs to are displayed in the classification display control step, the predetermined image area includes at least the lowest folder among the above folders.

16. The document management program according to claim 13, wherein
when an icon image corresponding to the document data displayed by the document image display control step is displayed in the classification display control step, the predetermined image area includes at least the icon image.

17. The document management program according to claim 13, wherein
the highlight display control step performs highlight display by changing at least one of display color, texture, display size, shape of the predetermined image area, and time intervals at which the predetermined image area is displayed.

18. The document management program according to claim 13, comprising
a document data storage step which stores the document data to be managed,
wherein when a predetermined image corresponding to the document data stored in the document data storage step is displayed by the document image display control step, the classification display control step performs classification display according to the classification assigned to the document data that has been set in the document data storage step.
